(19) United States
(12) Patent Application Publication
(10) Pub. No.: US 2026/0368719 A1
(43) Pub. Date: Nov. 19, 2026

(54) Token Activation System for Viewer Engagement and Microtransaction Optimization

(71) Applicant: Thang Tran, Erie, PA (US)

(72) Inventor: Thang Tran, Erie, PA (US)

(21) Appl. No.: 19/200,886

(22) Filed: May 7, 2025

(51) Int. Cl. G06Q 20/38; H04N 21/2187

(52) U.S. Cl. CPC G06Q 20/38; H04N 21/2187

(57) ABSTRACT

The Token Activation System ™ (TAS) is a non-algorithmic, tiered microtransaction engagement model for live-streaming platforms. It features a fixed Tier 1 action priced at one token (“Token of Sincerity”), which offers a universally available, low-friction entry point for viewer participation and recognition. Tiers 2, 3, and 4 escalate arbitrarily in content and price, based on performer definition. TAS requires Tier 1 and Tier 2 to dominate the menu, with an ideal distribution near 85/10/5. Public-facing AI filtering and adaptive manipulation are strictly prohibited. Consent-based behavioral AI may be used in private sessions for memory and continuity. TAS supports lightweight participation, recognition, and consistent access—without behavioral extraction.

### RELATED APPLICATION

This application claims the benefit of U.S. Provisional Patent Application No. 63/792,911, filed Apr. 23, 2025.

### DETAILED DESCRIPTION OF THE INVENTION

The Token Activation Engine™ (TAE) is a non-algorithmic behavioral engagement engine designed to facilitate structured viewer participation in live-streaming environments. Unlike adaptive systems that manipulate user behavior through filtering or prediction, TAE establishes a static, performer-controlled architecture that enables trust, consistency, and emotional pacing. It organizes all interaction opportunities into a fixed four-tier structure defined by the level of emotional commitment, effort, and recognition exchanged between viewer and performer. This framework allows viewers to participate freely while preserving the integrity of the emotional experience and performer autonomy.

The engine introduces a fixed Tier 1 interaction, called the “Token of Sincerity,” priced at exactly one token. While sincerity itself cannot be quantified, this mechanism offers a symbolic gesture—a single token—to express intent, presence, and emotional openness. It is not demanded but offered. One token to say “Hi,” not as a payment, but as an act of acknowledgment. This interaction serves as a minimal-friction behavioral trigger: it initiates the engagement loop, reduces hesitation, and conveys emotional meaning. The value lies not in the token, but in what it represents—sincerity given form. Performers recognize this action not as transactional, but as expressive, and their response completes a loop grounded in mutual recognition. Tier 1 is structurally protected as a universally visible, unfiltered entry point in all public-facing implementations of the engine.

Tier 2 interactions are defined by slightly elevated token values and are intentionally designed to support emotional pacing. These actions reflect casual, observational, or trust-building gestures that deepen engagement without escalating performance intensity. Tier 3 interactions involve moderate performer effort or tailored responses, while Tier 4 interactions are reserved for loyalty-based or high-commitment engagements. This escalation is not merely transactional—it is behavioral, enabling structured emotional progression and reinforcing the session's ethical rhythm.

The engine enforces a structured distribution model, not for the purpose of maximizing revenue, but to support emotional flow, inclusive participation, and shared enjoyment. Approximately 85% of tipping actions occur within Tier 1 and Tier 2, supporting lightweight gestures and emotional pacing. Tier 3 represents moderate personalization and accounts for approximately 10%, while Tier 4—reserved for loyalty-based gestures—comprises the final 5%. These ratios are not monetization targets but behavioral design boundaries. They ensure that viewers can express sincerity and receive acknowledgment without pressure, and that performers can earn income in a way that is emotionally sustainable and self-directed. TAE preserves this balance as a behavioral contract—one that prioritizes meaning over maximization.

TAE is designed to foster a sense of emotional presence rather than behavioral prediction. At the core of this experience is the concept of emotional pacing—a structured rhythm of interaction that encourages recognition, trust, and authentic engagement without escalating pressure or spectacle. Emotional pacing refers to trust-building, socially affirmative gestures such as name mentions, light compliments, gratitude, simple acknowledgments, or casual viewer-performer interactions that prioritize emotional resonance over transactional value. These moments are not optimized for conversion but crafted for connection. By embedding emotional pacing into Tier 2 and preserving lightweight entry through Tier 1, the engine sustains a space where viewers can express sincerity and be seen, and where performers can reciprocate without performance burden.

Claim 10 defines strict boundaries for the use of Behavioral AI within the Token Activation Engine. TAE is designed to operate without algorithmic manipulation of public interaction flow. In public-facing environments, any system that uses viewer history, behavioral modeling, or tipping patterns to adapt menus, reorder prompts, or change engagement pacing is structurally incompatible with the engine's purpose. Behavioral AI may be used only in background or infrastructure layers, where its role is limited to cryptographic validation, performance diagnostics, or memory continuity—and never influences public interaction. However, in adult entertainment contexts, Behavioral AI may play a valid and engaging role when used ethically and privately. By tailoring session flow to user preferences, AI can enhance the experience, create responsive fantasy frameworks, and make interactions more exciting. For this reason, TAE allows Behavioral AI in private or one-to-one sessions, provided its use is explicitly disclosed, consent is obtained, and it does not alter the public-facing behavior of the engine. This design maintains ethical transparency in public while permitting personalized enhancement in private spaces.

Claim 11 defines the structural and cryptographic safeguards that preserve the Token Activation Engine's behavioral integrity. The engine is intentionally non-adaptive, meaning all tiers must remain static in their configuration across public-facing implementations. Tipping menu tiers must be simultaneously visible to all viewers, regardless of engagement history, spending level, or prior behavior. This universal visibility ensures fairness, prevents psychological manipulation, and maintains an emotionally open interaction environment. Tier 1—the Token of Sincerity—must never be filtered, gated, or escalated through adaptive logic. Its visibility is foundational to TAS compliance. Customization of the tipping menu must be manual and performer-controlled, without any influence from predictive algorithms, escalation engines, or behaviorally reactive UI adjustments. To enforce these protections, the tipping menu cryptographically secured using technologies such as Elliptic Curve Digital Signature Algorithm (ECDSA) and SHA-256 hashing. These tools provide verifiable proof that the interface remains unaltered, preserving the static structure that defines TAS.

1. A non-algorithmic, tiered microtransaction engagement engine for live-stream environments, comprising:
(a) a tipping menu created and controlled manually by a performer;
(b) a fixed Tier 1 interaction priced at exactly one token, referred to as a “Token of Sincerity,” designed to initiate public, low-friction performer recognition;
(c) one or more Tier 2 interactions, priced arbitrarily above Tier 1, representing lightweight viewer participation;
(d) one or more Tier 3 interactions, priced arbitrarily above Tier 2, representing moderate-effort or personalized viewer-performer engagements; and
(e) one or more Tier 4 interactions, priced arbitrarily above Tier 3, reserved for high-commitment, loyalty-based experiences.

2. The engine of claim 1, wherein the tipping menu follows an 85/10/5 distribution structure, with approximately:
(a) 85% of actions in Tiers 1 and 2 combined, representing emotional activation and lightweight engagement;
(b) 10% in Tier 3, representing personalized or moderate-effort interactions; and
(c) 5% in Tier 4, reserved for high-commitment, loyalty-based actions.

3. The engine of claim 2, wherein Tier 1 and Tier 2 together constitute the structural and behavioral majority of the tipping menu, and wherein:
(a) statistical compliance is measured within a 95% confidence interval centered on a target distribution of 85% Tier 1 and Tier 2 combined;
(b) the acceptable compliance range for Tier 1 and Tier 2 combined is between 55% and 100% of the total menu structure;
(c) Tier 3 must constitute between 4% and 16% of the menu, and Tier 4 must not exceed the proportion of Tier 3 or disrupt the pacing model;
(d) within Tier 2, no less than 55% of actions reflect pure emotional pacing, defined as social recognition or trust-establishing gestures unlinked to spectacle or performance outcomes; and
(e) systems in which Tier 2 emotional pacing falls below 35%, or in which performance-driven actions dominate the structure, shall be deemed behaviorally divergent from TAS.

4. The engine of claim 1, wherein Tier 1 initiates a low-friction viewer-performer loop by offering a fixed, low-commitment interaction that invites participation through visible performer acknowledgment, and wherein the Token of Sincerity is defined not solely by price but by its function as an emotionally safe, publicly acknowledged entry point, and wherein any system that implements a non-tiered or alternative-cost interaction that performs the same viewer engagement function by reducing hesitation and triggering public performer response shall be subject to TAS compliance assessment under claim 11, and wherein such use, if deployed without adherence to structural and ethical provisions defined in claim 11, shall be considered a behavioral derivative and evaluated for infringement.

5. The engine of claim 1, wherein Tier 2 interactions include prompts designed for casual, observational, or playful participation, and wherein at least 30% of Tier 2 actions must be clearly identifiable as emotional pacing prompts including but not limited to recognition gestures, trust-building responses, soft social acknowledgments, or playfully personalized interaction cues, and wherein systems that fail to meet this 30% threshold within Tier 2 shall be considered structurally divergent from TAS, and wherein use of Tier 1 alone, when implemented with a public recognition trigger, constitutes a valid TAS instantiation under claims 1 and 2, and wherein such Tier 1-only implementations are subject to licensing or enforcement if used without authorization.

6. The engine of claim 1, wherein Tier 3 interactions involve higher performer effort or customized actions for viewers, including but not limited to naming the viewer, fulfilling specific viewer-triggered tasks, or providing personalized acknowledgments not pre-scripted in the tipping menu.

7. The engine of claim 1, wherein Tier 4 interactions are reserved for loyalty-based, high-commitment viewer experiences, including but not limited to unique access privileges, long-form personalized content, or high-value gesture responses intended to reinforce sustained performer-viewer trust and identity recognition.

8. The engine of claim 1, wherein public-facing tipping menus are prohibited from being filtered, gated, reordered, or dynamically adapted based on behavioral tracking, tipping frequency, or viewer history, and wherein performer-controlled personalization of the menu is permitted only when manually configured, without algorithmic enforcement, adaptive optimization, or real-time behavior modeling.

9. The engine of claim 1, wherein micro-engagement is supported by offering accessible, low-pressure participation paths in Tier 1 and Tier 2, and wherein such participation may include optional gamified or randomized interaction formats such as performer-approved spin wheels that utilize fixed menu items across Tier 1 through Tier 4, provided that all such features remain consistent with the integrity protections defined in claim 11 including static tier visibility, manual performer control, and non-adaptive outcome presentation, and wherein these features are considered compliant when designed to enhance spontaneous engagement, shared excitement, and performer-viewer connection without invoking behavior prediction or scarcity pressure.

10. The engine of claim 1, wherein:
(a) the use of Behavioral AI, defined as any system that uses viewer history, engagement patterns, tipping behavior, or predictive modeling to alter menu configuration, visibility, interaction prompts, or response flow, is expressly prohibited in all public-facing implementations of TAS;
(b) Behavioral AI may be permitted solely in background or infrastructure systems for the purpose of cryptographic validation, system performance optimization, or memory-based continuity;
(c) such permitted Behavioral AI use must not influence public interaction structure, token flow, tier visibility, or menu arrangement in any form;
(d) Behavioral AI may be conditionally applied in private or one-to-one sessions only when its use is disclosed clearly to the viewer, viewer consent is obtained prior to activation, and its operation does not alter or influence the public-facing behavior of the TAS interface; and
(e) any use of Behavioral AI to influence viewer tipping behavior, menu ordering, emotional pacing, or interaction intensity shall be deemed structurally divergent from TAS and void compliance eligibility.

11. The engine of claim 1, wherein:
(a) all tiers must remain static and non-adaptive in their configuration across public-facing implementations;
(b) all tipping menu tiers must be simultaneously visible to all viewers, regardless of tipping history, behavior, or engagement status;
(c) Tier 1 must remain universally accessible and must not be filtered, gated, or suppressed through adaptive or predictive logic;
(d) customization of the tipping menu must be manual and performer-controlled, with no algorithmic input, escalation suggestions, or behavioral targeting;
(e) the integrity of the tipping menu must be cryptographically secured using Elliptic Curve Digital Signature Algorithm (ECDSA) and SHA-256 hashing, or a functionally equivalent cryptographic method;
(f) any system that reproduces TAS structure but introduces behavioral prediction, adaptive gating, dynamic ranking, or manipulation of tipping visibility shall be deemed structurally divergent and infringing; and
(g) any Tier 1 interaction delivered within a dynamically modified or behaviorally filtered interface constitutes a violation of TAS compliance and voids licensing eligibility.

12. An engine for tiered engagement in live-streaming environments, comprising:
(a) an implementation of a fixed-entry, non-algorithmic microtransaction model based on a four-tier structure as defined by the Token Activation System™ (TAS);
(b) wherein said implementation is deployed on live-streaming platforms not limited to adult content, including but not limited to gaming, social broadcasting, creative performance, and educational contexts;
(c) wherein viewer-initiated token inputs trigger interaction events corresponding to fixed menu tiers, including a publicly visible Tier 1 entry interaction priced at exactly one token;
(d) wherein the system is delivered through one or more of application programming interfaces (API), browser extensions, OBS-compatible plugins, or software development kits (SDKs), while maintaining non-adaptive tier behavior and static visibility rules across all implementations;
(e) wherein claims 2, 10, and 11 are treated as structurally essential components of TAS deployment and any implementation omitting them shall be deemed non-compliant and ineligible for licensing or lawful derivative use;
(f) wherein any system utilizing Tier 1 or a materially similar low-friction entry gesture, without the inclusion of corresponding Tier 3 and Tier 4 layers, shall be considered a truncated derivative of TAS and in violation of its behavioral pacing structure; and
(g) wherein Tier 3 and Tier 4 interactions are defined as required elements for emotional continuity, personalization, loyalty reinforcement, and sustainable performer-viewer engagement, and may not be excluded without invalidating TAS compliance.
